(19) United States
(12) Patent Application Publication
(10) Pub. No.: US 2008/0298343 A1
(43) Pub. Date: Dec. 4, 2008

(54) VOIP PHONE NUMBER DISCOVERY ON PSTNS USING TWO WAY FXO COMMUNICATION

(75) Inventors: Nicholas F. Campion, Rochester, MN (US); Keith D. Cramer, Pine Island, MN (US); Harold J. Roberson, II, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/756,742

(22) Filed: Jun. 1, 2007

(51) Int. Cl. H04L 12/66

(52) U.S. Cl. 370/352

(57) ABSTRACT

A method for placing a telephone call using a Voice over Internet Protocol (VoIP), the method including using a foreign exchange office (FXO) of a first VoIP system, making a public switching telephone network (PSTN) connection with an FXO of a second VoIP system; exchanging at least an Internet telephone address between the FXOs; terminating the PSTN connection; and placing the telephone call from the first VoIP system to the second VolP system over the Internet using the Internet telephone address.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The present invention relates to the field of telephony.

2. Description of the Related Art

Telephone calls that most people are familiar with are placed on a Public Switching Telephone Network (PSTN). Similarly, telephone numbers that most people are familiar with are located on the PSTN. When a person sees telephone numbers in a telephone book, those telephone numbers are PSTN numbers. Local and long distance carriers try to establish a telephone call to an end point using the PSTN number. For telephone calls to a PSTN number, there is typically a charge. The charge may be referred to as a “PSTN carrier charge.” There are ways to establish telephone calls with no PSTN carrier charge.

One way is to place telephone calls using the Internet. Telephone calls placed over the Internet involve one Internet user calling another Internet user. The telephone calls placed over the Internet use the Internet as a digital data connection. The telephone calls placed over the Internet are free from PSTN carrier charges because the PSTN is not involved with the digital data connections involving the Internet. The telephone calls placed over the Internet are referred to as “Voice over Internet Protocol” (VoIP) telephone calls.

The VoIP telephone calls do not use the PSTN numbers. Instead, each Internet location is assigned a unique “Session Initiation Protocol” (SIP) address (typically, UserName@SystemName). To make a VoIP telephone call, a party placing the telephone needs to use the SIP address instead of the PSTN number.

It is also possible for a VoIP user to call a non-VoIP user. The VoIP user can place a telephone call to the non-VoIP user by specifying the PSTN number of the non-VoIP user. With VoIP to Non-VoIP telephone calls, a VoIP sever typically bridges the telephone call from the Internet to the PSTN. The VoIP server makes the VoIP to non-VoIP telephone calls appear seamless to the users. The VoIP server may be referred to as a “Foreign Exchange Office” (FXO). The FXO can be used to bridge Internet telephone calls into the PSTN and to bridge PSTN telephone calls into the Internet. Typically, when telephone calls are bridged either into or out of the PSTN, there is a PSTN carrier charge.

As VoIP telephone calls become more prevalent, many companies are turning to using VoIP as a way to save money. A company using VoIP typically lists an Internet telephone address different from the PSTN number. VoIP users wanting to use VoIP to call the company need to use the Internet phone address. The VoIP user wanting to call the company but not knowing the Internet phone address can still call the PSTN number. However, calling the PSTN number will invoke the PSTN carrier charge. To the caller, calling either the PSTN number or the Internet phone address results in a seamless telephone call, one difference being the PSTN carrier charge.

What are needed are an apparatus and a method for a VoIP user to place a telephone call to the PSTN number of another VoIP user while minimizing or not incurring the PSTN carrier charge.

### SUMMARY OF THE INVENTION

The shortcomings of the prior art are overcome and additional advantages are provided through the provision of a method for placing a telephone call using a Voice over Internet Protocol (VoIP), the method including using a foreign exchange office (FXO) of a first VoIP system, making a public switching telephone network (PSTN) connection with an FXO of a second VoIP system; exchanging at least an Internet telephone address between the FXOs; terminating the PSTN connection; and placing the telephone call from the first VoIP system to the second VoIP system over the Internet using the Internet telephone address.

Also disclosed is a computer program product stored on machine readable media including machine readable instructions for placing a telephone call using a Voice over Internet Protocol (VoIP), the instructions including instructions for using a foreign exchange office (FXO) of a first VoIP system, making a public switching telephone network (PSTN) connection with an FXO of a second VoIP system; sending a VoIP capability check from the FXO of the second VoIP system to the FXO of the first VoIP system; sending an answer declaring a VoIP capability from the FXO of the first VoIP system to the FXO of the second VoIP system; sending an Internet telephone address from the FXO of the second VoIP system to the FXO of the first VoIP system; sending an acknowledgment of receipt of the Internet telephone address from the FXO of the first VoIP system to the FXO of the second VoIP system; terminating the PSTN connection; and placing the telephone call from the first VoIP system to the second VoIP system over the Internet using the Internet telephone address.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which saves communications costs through a method for placing a telephone call using a Voice over Internet Protocol (VoIP), the method including using a foreign exchange office (FXO) of a first VoIP system, making a public switching telephone network (PSTN) connection with an FXO of a second VoIP system; exchanging at least an Internet telephone address between the FXOs; terminating the PSTN connection; and placing the telephone call from the first VoIP system to the second VoIP system over the Internet using the Internet telephone address.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a prior art example of placing a VoIP telephone call through a PSTN;

FIG. 2 depicts aspects of placing the VoIP telephone call through FXOs with a signaling protocol; and

FIG. 3 illustrates an exemplary method for placing VoIP telephone calls through FXOs with the signaling protocol.

The detailed description explains the preferred embodiments of the invention, together with advantages and features, by way of example with reference to the drawings.

### DETAILED DESCRIPTION OF THE INVENTION

The teachings provide a method and apparatus for a VoIP user to place a telephone call on a PSTN without incurring a PSTN carrier charge. The method and apparatus automatically detect if a party being called has an Internet telephone address. If an Internet telephone address is detected, the teachings provide for automatically routing the telephone call through the Internet thereby avoiding or minimizing any PSTN carrier charges. To understand the teachings, a prior art example of placing a telephone call from one VoIP business user to another VoIP business user is presented.

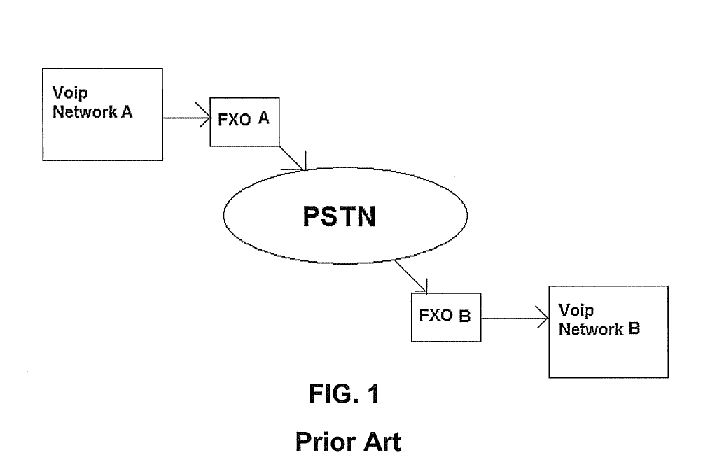

FIG. 1 illustrates a prior art example of placing a long distance telephone call between two VoIP business users when an Internet telephone address is unknown to a caller. Both companies A and B have VoIP networks installed at their business locations. Unfortunately, the employees of companies A and B do not know each other's Internet phone addresses. If someone at company A wants to place a telephone call to a person at company B, then the person at company A will place the telephone call using a PSTN number for the person at company B. Employees at company A are typically connected to a VoIP Network A. The telephone call will proceed from the VoIP Network A (for company A) to an FXO A. At the FXO A, a digital audio signal from the VoIP Network A is converted to an analog audio signal. Typically, analog audio signals are used as inputs and outputs to the PSTNs. The analog audio signals are transmitted via the PSTN to an FXO B at company B. The FXO B converts the analog audio signal from the PSTN to a digital audio signal. The digital audio signal is then transmitted to a VoIP Network B where the telephone call can be directed to the person at company B. A problem with this example is that company A incurs a PSTN carrier charge. Another problem is that company A and company B paid for VoIP technology that is being underutilized.

The teachings provide FXOs that can communicate with each other via a PSTN connection. Communications provide for exchanging information that is used for placing a VoIP telephone call. The FXOs communicate with a signaling protocol. In one exemplary embodiment, the signaling protocol is communicated by short tone bursts. The tone bursts may or may not be audible to a caller. The FXOs exchange information regarding VoIP capabilities at each FXO site via the PSTN. The information includes the Internet telephone address of a party being called, if the party being called has an Internet telephone address. If the party being called has an Internet telephone address, then the FXO receiving the telephone call terminates the PSTN connection. The FXO making the telephone call routes the telephone call through the Internet to the Internet telephone address.

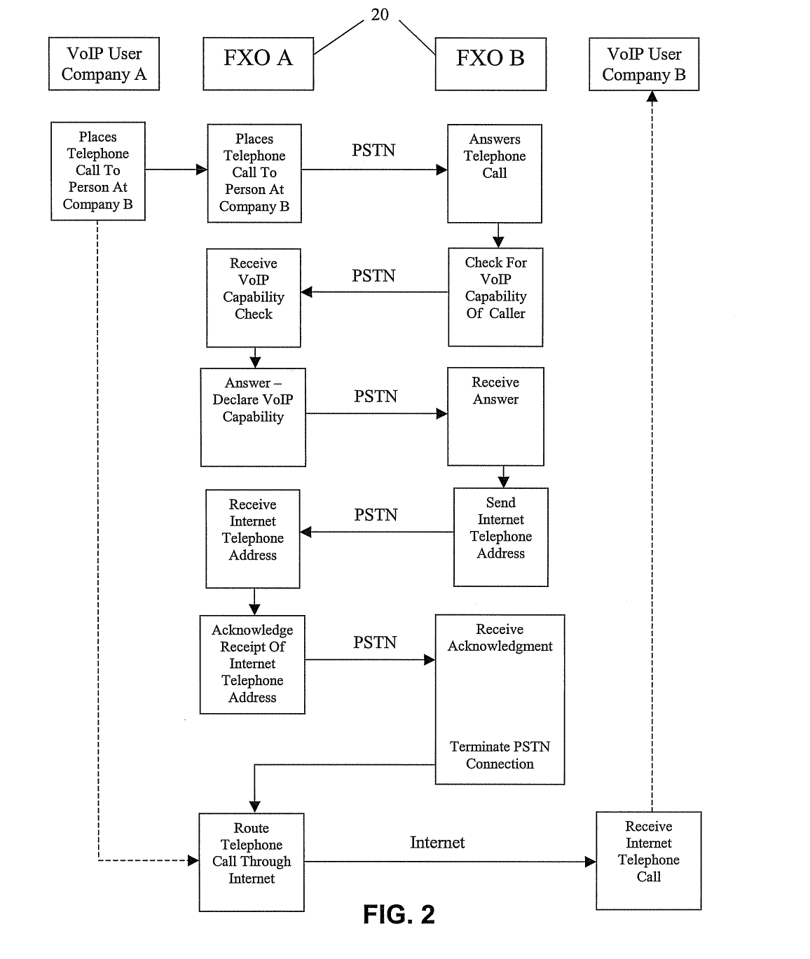

FIG. 2 depicts aspects of a process for making a VoIP telephone call through FXOs that have the signaling protocol. Referring to FIG. 2, an FXO 20 (FXO A) interfaces with a VoIP user at company A. Similarly, another FXO 20 (FXO B) interfaces with a VoIP user at company B. The FXOs 20 have the signaling protocol discussed above. For purposes of discussion, the VoIP user at company A (User A) places a call to the VoIP user at company B (User B). However, User A does not know that User B has VoIP capability. Therefore, User A calls User B using a PSTN number and a PSTN connection. Because the telephone call is made to the PSTN number, FXO A converts a digital audio signal to an analog audio signal for input to the PSTN. FXO B answers the telephone call because the telephone call comes in on the PSTN. Because FXO B has the signaling protocol, FXO B sends a message to FXO A to determine if User A has VoIP capability. The message is referred to as a “VoIP capability check.” FXO A receives the message and sends an answer back to FXO B. The answer includes information that User A has VoIP capability. FXO B receives the answer and sends the Internet telephone address for User B to FXO A. FXO A receives the Internet telephone address and sends an acknowledgment of receipt back to FXO B. Upon receiving the acknowledgment, FXO B terminates the PSTN connection. FXO A routes the telephone call through the Internet to the Internet telephone address. The process of making the telephone call starting with the PSTN number is seamless to User A.

With respect to the above discussion, if User A does not have VoIP capabilities, then FXO B will not receive an answer declaring VoIP capabilities. FXO B will then establish a connection with User B. Accordingly, the telephone call will proceed via the PSTN.

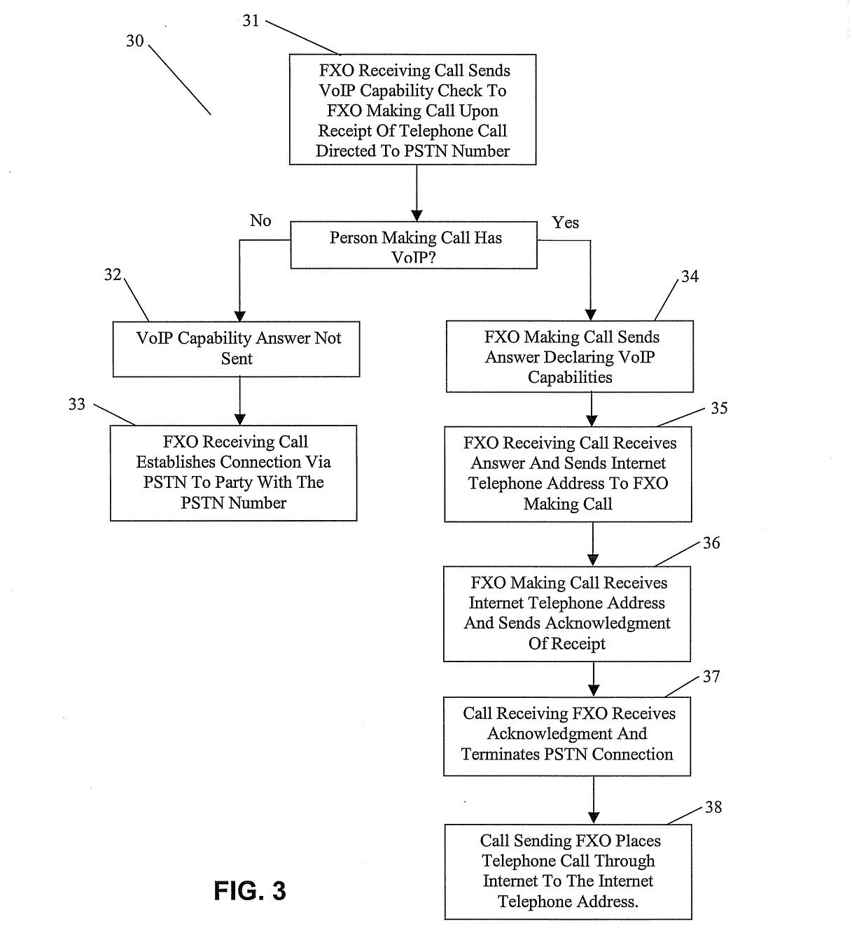

FIG. 3 illustrates an exemplary method 30 of placing a telephone call directed to a PSTN number over the Internet. A first step 31 calls for an FXO 20 receiving a telephone call directed to a PSTN number to send a VoIP capability check to the caller. A second step 32 calls for not sending an answer if the caller does not have VoIP capability. Further, a third step 33 calls for the FXO 20 receiving the telephone call to establish a connection via the PSTN to the party with the PSTN number (if the caller does not have VoIP capability). If the caller does have VoIP capability, then a fourth step 34 calls for the FXO 20 making the telephone call to send an answer declaring VoIP capabilities. A fifth step 35 calls for the FXO 20 receiving the telephone call to receive the answer and send the Internet telephone address of the party with the PSTN number. A sixth step 36 calls for the FXO 20 making the telephone call to receive the Internet telephone address and send an acknowledgment of receipt. A seventh step 37 calls for the FXO 20 receiving the telephone call to receive the acknowledgment and terminate the PSTN connection. An eighth step 38 calls for the FXO making the telephone call to place the telephone call via the Internet to the Internet telephone number.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for placing a telephone call using a Voice over Internet Protocol (VoIP), the method comprising:
using a foreign exchange office (FXO) of a first VoIP system, making a public switching telephone network (PSTN) connection with an FXO of a second VoIP system;
exchanging at least an Internet telephone address between the FXOs;
terminating the PSTN connection; and
placing the telephone call from the first VoIP system to the second VoIP system over the Internet using the Internet telephone address.

2. The method as in claim 1, further comprising sending a VoIP capability check from the FXO of the second VoIP system to the FXO of the first VoIP system.

3. The method as in claim 1, further comprising sending an answer declaring a VoIP capability from the FXO of the first VoIP system to the FXO of the second VoIP system.

4. The method as in claim 1, further comprising sending an acknowledgment of receipt of the Internet telephone address from the FXO of the first VoIP system to the FXO of the second VoIP system.

5. A computer program product stored on machine readable media comprising machine readable instructions for placing a telephone call using a Voice over Internet Protocol (VoIP), the instructions comprising instructions for:
using a foreign exchange office (FXO) of a first VoIP system, making a public switching telephone network (PSTN) connection with an FXO of a second VoIP system;
sending a VolP capability check from the FXO of the second VoIP system to the FXO of the first VoIP system;
sending an answer declaring a VoIP capability from the FXO of the first VoIP system to the FXO of the second VoIP system;
sending an Internet telephone address from the FXO of the second VoIP system to the FXO of the first VoIP system;
sending an acknowledgment of receipt of the Internet telephone address from the FXO of the first VoIP system to the FXO of the second VoIP system;
terminating the PSTN connection; and
placing the telephone call from the first VoIP system to the second VoIP system over the Internet using the Internet telephone address.
